(19) United States
(12) Patent Application Publication
(10) Pub. No.: US 2008/0125166 A1
(43) Pub. Date: May 29, 2008

(54) INFORMATION EXCHANGE BETWEEN COMMUNICATIONS DEVICES

(75) Inventors: Brian M. NOVACK, Saint Louis, MO (US); Jason E. HICKS, Edwardsville, IL (US); Timothy R. THOMPSON, Wentzville, MO (US)

Correspondence Address: GREENBLUM & BERNSTEIN, P.L.C., 1950 ROLAND CLARKE PLACE, RESTON, VA, 20191, US

(73) Assignee: AT&T KNOWLEDGE VENTURES, L.P., Reno, NV (US)

(21) Appl. No.: 11/559,109

(22) Filed: Nov. 13, 2006

(51) Int. Cl. H04Q 7/20

(52) U.S. Cl. 455/551

(57) ABSTRACT

A communications device includes a bidirectional communications module configured to enable bidirectional communications. A memory stores information, and a destination address obtainer obtains a destination address, determined based on predetermined criteria, for sending selected stored information.

### BACKGROUND OF THE DISCLOSURE

1. Field of the Disclosure

The present disclosure relates to communications devices, More particularly, the present disclosure relates to selecting and presenting addresses to which stored data is to be sent using a communications device user interface.

2. Background Information

Communications devices such as cell phones are often provided with data storage systems. However, such data storage systems are typically designed with the intent that stored data will remain on the communications device on which the data storage system resides. Even on communications devices which allow sharing of stored data, a user must navigate an extensive menu-driven user interface to reach a menu which allows selection of stored data to be forwarded. On such a communications device, a user must also manually input a destination to which the selected stored data is to be sent. On communications devices as described above, it is awkward for the user to find and select stored data and then manually input the destination address to which the stored data is to be sent.

### BRIEF DESCRIPTION OF THE DRAWINGS

The present disclosure is further described in the detailed description that follows, by reference to the noted drawings by way of non-limiting examples of embodiments of the present disclosure, in which like reference numerals represent similar parts throughout several views of the drawing, and in which:

FIG. 1 shows an exemplary general computer system that includes a set of instructions for performing information exchange between communications devices;

FIG. 2 shows exemplary communications networks for information exchange between communications devices;

FIG. 3 shows an exemplary communications device for information exchange between communications devices;

FIG. 4 shows an exemplary communications device for information exchange between communications devices; and

FIG. 5 shows an exemplary method for performing information exchange between communications devices.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure, a communications device includes a bidirectional communications module configured to enable bidirectional communications. A memory stores information, and a destination address obtainer obtains a destination address, determined based on predetermined criteria, for sending selected stored information.

According to another aspect of the present disclosure, the communications device includes an address presenter configured to present the determined destination address. A dedicated user interface enables a user to select a set of destination addresses among multiple destination addresses obtained by the destination address obtainer.

According to yet another aspect of the present disclosure, the dedicated user interface enables the user to select stored information to send to at least one other communications device.

According to still another aspect of the present disclosure, an information communications module is provided for sending selected information to the at least one other communications device.

According to another aspect of the present disclosure, the information communications module is configured to send the selected information to the at least one other communications device as a unidirectional communication during a bidirectional communications session between the communications device and the at least one other communications device.

According to yet another aspect of the present disclosure, the bidirectional communication session is a cellular telephone call.

According to still another aspect of the present disclosure, the information communications module sends the selected information as a unidirectional communication.

According to another aspect of the present disclosure, the stored information includes address book profile information.

According to yet another aspect of the present disclosure, the stored information includes a media file.

According to still another aspect of the present disclosure, the stored information includes a public key.

According to another aspect of the present disclosure, the dedicated user interface includes a push button.

According to yet another aspect of the present disclosure, the dedicated user interface includes a touchscreen.

According to still another aspect of the present disclosure, the dedicated user interface presents navigable menus.

According to another aspect of the present disclosure, the bidirectional communications module is configured to communicate simultaneously with at least one other communications device in a conference call.

According to yet another aspect of the present disclosure, a graphical user interface is configured to present a contact list.

According to still another aspect of the present disclosure, the dedicated user interface includes multiple selection keys each for invoking a different function related to enabling a user to at least one of select and input information.

According to another aspect of the present disclosure, the predetermined criteria includes an address of a last call between the communications device and at least one other communications device.

According to yet another aspect of the present disclosure, the predetermined criteria includes an address of at least one other communications device with which the communications device is communicating bi-directionally.

According to still another aspect of the present disclosure, the predetermined criteria includes addresses of multiple other communications devices with which the communications device is communicating bi-directionally.

According to an aspect of the present disclosure, a method is provided for obtaining a destination address for sending information from a communications device. The method for obtaining the destination address includes storing information in a memory of a communications device configured to enable bidirectional communications. A destination address, determined based on predetermined criteria, is obtained for sending selected stored information.

According to an aspect of the present disclosure, a computer readable medium is provided for storing a computer program that obtains a destination address for sending information from a communications device. The computer readable medium includes an information storing code segment that stores information in a memory of a communications device configured to enable bidirectional communications. The computer readable medium also includes a destination address obtaining code segment that obtains a destination address, determined based on predetermined criteria, for sending selected stored information.

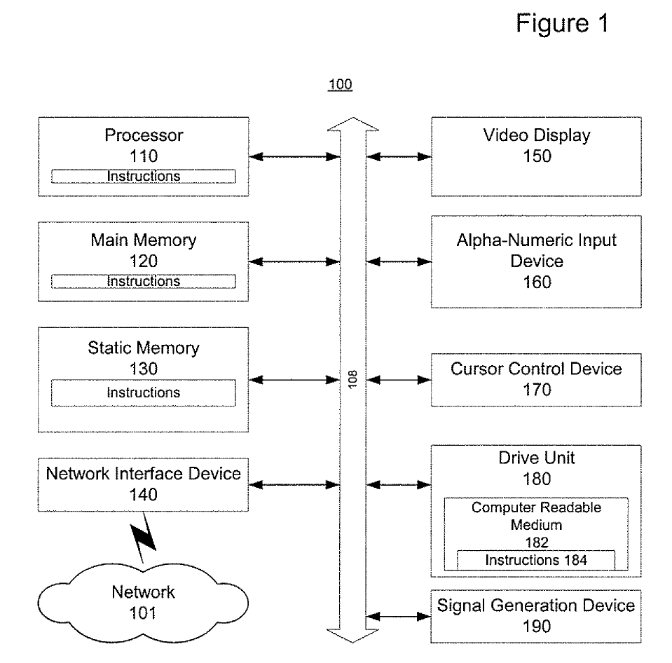

Referring to FIG. 1, an illustrative embodiment of a general computer system, on which a method for information exchange between communications devices can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal digital assistant (PDA), a mobile device, a palmtop computer, a laptop computer, a mobile telephone, a pager, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Using a communications device with a general computer system as shown in FIG. 1, a user can communicate bi-directionally with at least one other communications device. The user may also send stored data and information to at least one other communications device as a uni-directional communication.

The communications device includes a memory that stores information. The memory that stores information may be the main memory 120 or the static memory 130 shown in FIG. 1, for example. A destination address obtainer obtains a destination address, determined based on predetermined criteria, for sending selected stored information. The destination address obtainer may be the processor 110 shown in FIG. 1, for example. The determination of the destination address may be performed on the communications device or within a network over which the communications device communicates.

An address presenter presents the determined destination address. The address presenter may be the video display 150, for example, or another display or graphical user interface. Alternatively, the address presenter may be a voice response module that presents a destination address as an audible announcement. The destination address may be presented as a contact name, an image and/or as an address such as a telephone number or email address.

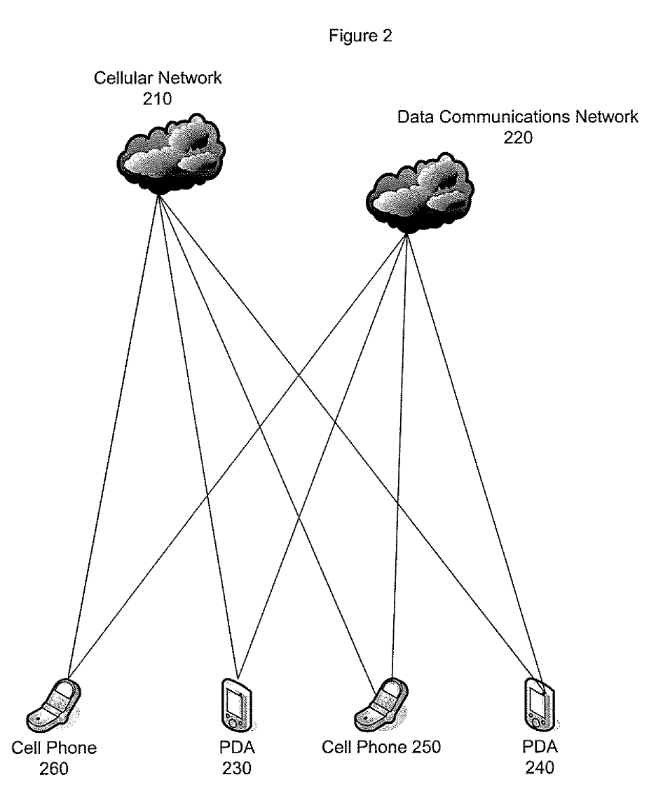

FIG. 2 illustrates exemplary communications networks for information exchange between communications devices. As shown, mobile personal digital assistants (PDAs) 230, 240 and mobile cell phones 250, 260 are able to communicate over each of the cellular network 210 and the data network 220. The personal digital assistants 230, 240 and cell phones 250, 260 are mobile communications devices. The cellular network 210 is a bidirectional communications network that enables users of communications devices to communicate bi-directionally in bidirectional communications sessions, such as telephone calls. The data network 220 enables users to communicate uni-directionally by sending messages and data as, e.g., email or text messages.

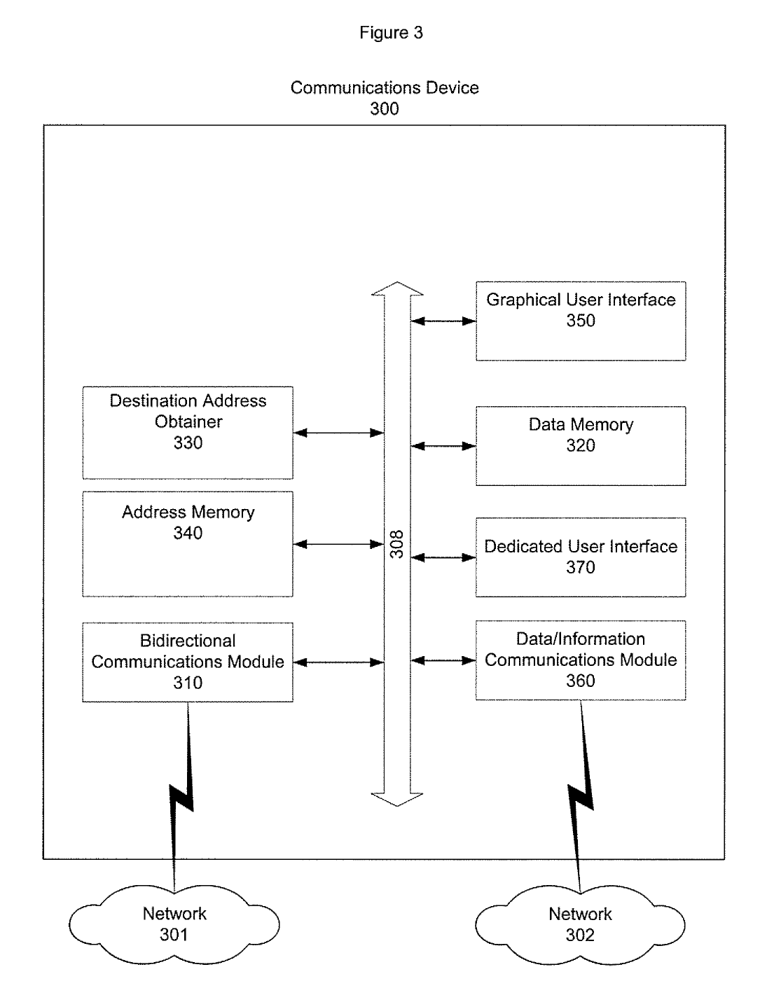

FIG. 3 illustrates an exemplary communications device 300 for information exchange between communications devices. The exemplary communications device 300 shown in FIG. 3 may correspond to any of the personal digital assistants 230, 240 or the cell phones 250, 260 shown in FIG. 2, as well as any other communications device that enables bidirectional and unidirectional communications as described above. The communications device 300 of FIG. 3 may include a general computer system such as that shown in FIG. 1.

The communications device 300 shown in FIG. 3 includes a bus 308 that corresponds to the bus 108 shown in FIG. 1. A bidirectional communications module 310 is configured to enable bidirectional communications between the communications device 300 and another remote communications device (not shown). The bidirectional communications module 310 is configured to enable the communications device 300 to communicate simultaneously with multiple other communications devices, for example, in a conference call.

A data memory 320 stores data, such as pictures, contact information (e.g., phone numbers, email addresses), electronic business cards, public keys or any other type of data that can be stored on a communications device. Accordingly, the selected stored information which may be sent as a unidirectional communication includes any type of data that can be stored on the communications device 300 or in an external memory on behalf of a user of the communications device 300.

A destination address obtainer 330 may be, e.g., a processor that determines and retrieves destination addresses from a memory on the communications device 300 such as address memory 310. In other words, the destination addresses are retrieved for presentation to a user of the communications device 300, and may be determined based on predetermined criteria by the destination address obtainer 330. Alternatively, the destination address obtainer 330 may be a module that retrieves destination addresses from a node on a communications network such as cellular communications network 210 and data communications network 220 shown in FIG. 2. In other words, the destination addresses which are retrieved for presentation to a user of the communications device 300 may be determined based on predetermined criteria at a node in the communications network. As explained below, a user may be presented with addresses determined to be addresses to which the user is likely to want to send selected stored data and information.

The address memory 340 may store addresses such as those obtained by the destination address obtainer 330. The address memory 340 may store addresses based on specific input from a user of the communications device 300 and/or based on addresses of other communications devices from which communications are received or to which communications are sent. In the embodiment where the destination address obtainer 330 determines destination addresses for presentation to the user, the destination address obtainer 330 obtains the destination addresses from the address memory 340.

A graphical user interface 350 is configured to display data and addresses for selection by the user. The graphical user interface 350 may also store navigable menus for presenting and selecting data and information, selecting and presenting destination addresses, and any other functions performed using the communications device 300. The graphical user interface 350 is configured to present a set of one or more destination addresses obtained by the destination address obtainer 330.

A data/information communications module 360 is configured to enable the communications device 300 to send data communications to and receive data communications from other remote communications devices (not shown). The data/information communications module 360 may send and receive email, text messages, electronic business cards, images or any other type of data that can be stored in the data memory 320. When a user selects information and one or more destination addresses, the data/information communications module 360 sends the selected information to one or more communications device corresponding to the selected destination addresses.

A dedicated user interface 370 provides functionality for obtaining and selecting data, information and destination addresses. The dedicated user interface 370 enables a user to select a set of destination addresses from among multiple destination addresses obtained by the destination address obtainer 330. The dedicated user interface 370 may also enable the user to select and send stored data and information to one or more communications device corresponding to the selected destination addresses. The dedicated user interface 370 may be a push button, a touchscreen or any other type of interface dedicated to enabling a user to activate functionality for selecting data and destination addresses to which the data can be sent. Of course, interaction by the user with the dedicated user interface 370 may lead to navigable menus being presented on the graphical user interface 350. The dedicated user interface 370 may include multiple selection keys, each for invoking a different function related to enabling the user to select and/or input information.

The bidirectional communications module 310 communicates over a network 301, which may correspond to the bidirectional cellular communications network 210 shown in FIG. 2. The data/information communications module 360 also communicates over a network 302, which may correspond to the unidirectional data communications network 220 shown in FIG. 2.

The data/information communications module 360 is configured to enable the communications device 300 to send selected data and information to another communications device as a unidirectional communication over the network 302. The selected data and information may be sent during a bidirectional communications session between the communications device 300 and the other communications device, or when a bidirectional communications session is not taking place between the communications device 300 and any other communications device. As an example, even in the midst of a cellular telephone call a user may select and send data to another party using the data/communications module 360. The data/information communications module 360 enables the communications device 300 to send the selected information as a unidirectional communication even while the user of the communications device 300 is engaged in a bidirectional communications session with another communications device. For example, the user may interact with the dedicated user interface 370 to invoke data selection and/or data sending functionality such that destination addresses or a menu for stored data are presented to the user while the user is engaged in the bidirectional communications session.

When the user interacts with the dedicated user interface 370, one or more addresses may be obtained based on predetermined criteria. The obtained addresses may be presented via the graphical user interface 350 or another interface. The predetermined criteria for obtaining addresses may include, for example, an address of a last call between the communications device 300 and another communications device or an address of another communications device with which the communications device is currently communicating bi-directionally. Further, the predetermined criteria may include addresses of multiple other communications devices with which the communications device 300 is communicating bi-directionally. The predetermined criteria may include groups of addresses associated with the data and information to be sent, as well as groups of addresses previously specified by a user of the communications device 300. In other words, the predetermined criteria may be any set of criteria that can be used to determine one or more destination addresses to which the user of the communications device 300 would likely want to send selected stored data and information. In an embodiment, the predetermined criteria are specified by the user. Alternatively, the service provider or equipment manufacturer may set the available predetermined criteria.

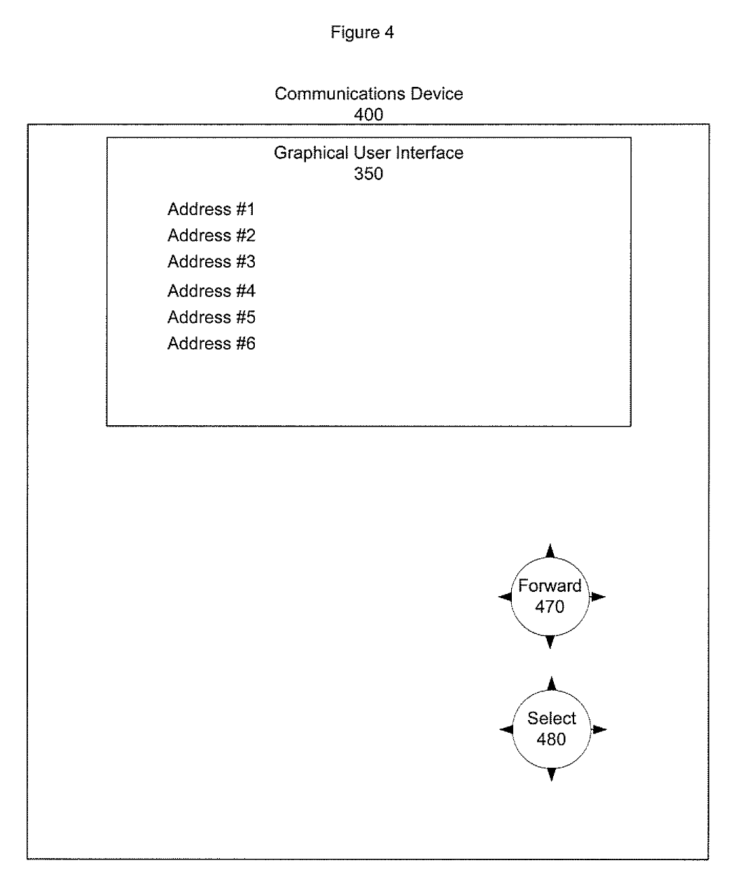

FIG. 4 illustrates the front panel of an exemplary communications device 400 for information exchange between communications devices. As shown in FIG. 4, the communications device 400 includes a graphical user interface 350 (described above with respect to FIG. 3) which displays a set of one or more obtained destination addresses. A forward button 470 and a select button 480 are also provided on the communications device 400 shown in FIG. 4. The forward button 470 and the select button 480 are examples of the dedicated user interface 370, shown in FIG. 3.

The forward button 470 may be used to invoke an option to forward data without requiring interaction with general menus provided on the communications device 400. By pressing the forward button 470, the communications device 400 may obtain a set of destination addresses based on predetermined criteria and display the obtained destination addresses on the graphical user interface 350. The select button 480 may be used to invoke an option to select data for forwarding without requiring interaction with general menus provided on the communications device 400. By pressing the select button 480, the communications device 400 may present the user with options for selecting stored data and information to send to a selected address. Of course, the options invoked by interaction with either the forward button 470 or the select button 480 may include an interactive menu or set of menus which can be navigated by the user. However, such menus may be limited to functionality associated with selecting stored data and information and sending the selected data and information to one or more addresses selected by a user of the communications device 400.

Accordingly, the forward button 470 and the select button 480 may be used together to select and send data to one or more addresses obtained based on predetermined criteria as described herein. The user is not required to navigate an extensive menu-driven user interface to reach menus which allow presentation and selection of stored data and information to be forwarded, and presentation and selection of addresses to which the selected data and information can be forwarded. Further, the user is not required to manually input a destination to which the selected stored data is to be sent.

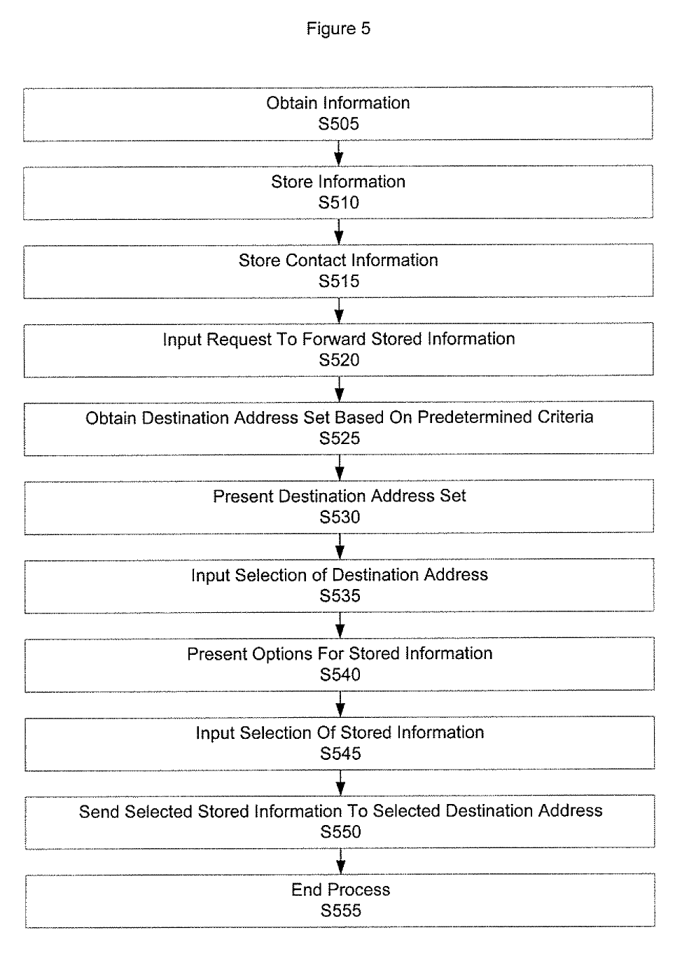

FIG. 5 illustrates an exemplary method for performing information exchange between communications devices. As shown, information is obtained at S505, for example, by the destination address obtainer 330, shown in FIG. 3. The information may be obtained when the user inputs data, uses the communications device to capture data, or receives data. At S510, the obtained data is stored in the communications device, for example, in the data memory 320.

At S515, the user stores contact information in the communications device, for example, in the address memory 340. The contact information of another party may be obtained from a communications network when a call or message is received over the communications network. Alternatively, the contact information of the other party may be obtained when the user inputs contact information of the other party. In either case, the contact information is stored in the communications device as, e.g., an entry in a contact list.

At S520, a request to forward stored information is input. The request may be input when a user of the communications device interacts with an interface, such as the dedicated user interface 370 shown in FIG. 3. At S525, one or more destination addresses are obtained as a default based upon predetermined criteria. For example, the default destination addresses may be obtained from a node in the network which determines the address of one or more other parties in the last call to or from the communications device. Of course, the default destination addresses may be one or more addresses stored on the communications device.

The predetermined criteria can be any logical rule or set of rules used to determine an address or addresses to which a user of the communications device likely will want to send selected data and information. The predetermined criteria may be a set of addresses of one or more remote communications devices with which the communications device is currently or was recently involved in a call or other bi-directional communication. The predetermined criteria may also be a set of contacts which are grouped by the user as, e.g., a friends group, a work group, a family group, a default group for sending selected data and information, or any other type of set of contacts which can be selected and grouped by the user of the communications device 300.

At S530, the obtained set of destination addresses are presented to a user via a user interface on the communications device. The user interface may be a graphical user interface (e.g., graphical user interface 350 in FIG. 3), a touch screen, a voice response module, or any other interface that is configured to present information such as a destination address to a user. At S535, a selection of a destination address is input, One or more destination addresses may be input by a user using a selection function of the dedicated user interface 370 shown in FIG. 3. Alternatively, the selected destination addresses may be input via speech to a voice response module when a user speaks a name of a contact on the contact list.

At S540, options for stored information are presented to the user. For example, the user may be presented with menu options via the graphical user interface 350. The menu options may include, e.g., “pictures”, “business card”, “contact information”, “message”, “media file” or any other option descriptive of data which can be stored in the communications device. In an embodiment, selection of any particular option leads to a presentation of additional options of particular data of the selected data type. At S545, the selection of particular stored information is input into the communications device. At S550, the selected stored information is sent to the selected destination address, and at S555 the process ends.

As described above, a user of a communications device is presented with destination addresses to which data can be sent. The destination addresses are determined based upon predetermined criteria, and can be determined on the communications device or in a communications network over which the communications device communicates. Using the presented destination addresses, a user can forward selected data and information to a remote communications device without manually inputting the destination address. Further, using the dedicated user interface, a user can initiate the process of forwarding data and information to a remote communications device without navigating menus unrelated to the functionality of selecting and forwarding data and information and selecting a set of one or more addresses to which the selected data and information can be forwarded. Additionally, where multiple dedicated user interfaces are provided, such as the forward button 470 and the select button 480, the user of the communications device is able to avoid navigation through unrelated menus when selecting and sending data and information to the remote communications device. As described above, the user is also presented with determined destination addresses which can be selected as the addresses to which selected data and information can be sent.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As an example, the actions in the method of FIG. 5 may be rearranged, such that the user selects stored information before selecting destination addresses to which the stored information is to be sent. Additionally, the forward button 470 and the select button 480 shown in FIG. 4 may be general purpose selection buttons which activate menus for the functionality described herein when a user uses the general purpose selection buttons in a particular manner (e.g., by pressing the down arrow portion). Accordingly, the user may be presented with a set of destination addresses, determined based on predetermined criteria, even when a general menu-driven user interface, instead of one or more dedicated user interfaces, is provided to invoke the option of obtaining and presenting a set of destination addresses.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A communications device, comprising:
a bidirectional communications module configured to enable bidirectional communications;
a memory for storing information; and
a destination address obtainer for obtaining a destination address, determined based on predetermined criteria, for sending selected stored information.

2. The communications device according to claim 1, further comprising:
an address presenter configured to present the determined destination address; and
a dedicated user interface for enabling a user to select a set of destination addresses among a plurality of destination addresses obtained by the destination address obtainer.

3. The communications device according to claim 2,
wherein the dedicated user interface enables the user to select stored information to send to at least one other communications device.

4. The communications device according to claim 3, further comprising:
an information communications module for sending selected information to the at least one other communications device.

5. The communications device according to claim 4,
wherein the information communications module is configured to send the selected information to the at least one other communications device as a unidirectional communication during a bidirectional communications session between the communications device and the at least one other communications device.

6. The communications device according to claim 5,
wherein the bidirectional communication session is a cellular telephone call.

7. The communications device according to claim 1,
wherein the information communications module sends the selected information as a unidirectional communication.

8. The communications device according to claim 1,
wherein the stored information comprises address book profile information.

9. The communications device according to claim 1,
wherein the stored information comprises a media file.

10. The communications device according to claim 1,
wherein the stored information comprises a public key.

11. The communications device according to claim 2,
wherein the dedicated user interface comprises a push button.

12. The communications device according to claim 2,
wherein the dedicated user interface comprises a touchscreen.

13. The communications device according to claim 2,
wherein the dedicated user interface presents navigable menus.

14. The communications device according to claim 1,
wherein the bidirectional communications module is configured to communicate simultaneously with at least one other communications device in a conference call.

15. The communications device according to claim 1, further comprising:
a graphical user interface configured to present a contact list.

16. The communications device according to claim 2,
wherein the dedicated user interface comprises a plurality of selection keys each for invoking a different function related to enabling a user to at least one of select and input information.

17. The communications device according to claim 1,
wherein the predetermined criteria comprises an address of a last call between the communications device and at least one other communications device.

18. The communications device according to claim 1,
wherein the predetermined criteria comprises an address of at least one other communications device with which the communications device is communicating bi-directionally.

19. The communications device according to claim 1,
wherein the predetermined criteria comprises addresses of a plurality of other communications devices with which the communications device is communicating bi-directionally.

20. A method of obtaining a destination address for sending information from a communications device, comprising:
storing information in a memory of a communications device configured to enable bidirectional communications; and
obtaining a destination address, determined based on predetermined criteria, for sending selected stored information.

21. A computer readable medium for storing a computer program that obtains a destination address for sending information from a communications device, comprising:
an information storing code segment that stores information in a memory of a communications device configured to enable bidirectional communications; and
a destination address obtaining code segment that obtains a destination address, determined based on predetermined criteria, for sending selected stored information.
